(19) United States
(12) Patent Application Publication
(10) Pub. No.: US 2020/0217237 A1
(43) Pub. Date: Jul. 9, 2020

(54) HEAT SHIELD HAVING A SEALING ELEMENT

(71) Applicant: REINZ-DICHTUNGS-GMBH, NEU-ULM (DE)

(72) Inventors: HANS WALDVOGEL, KRUMBACH (DE); OLIVER CLAUS, LAICHINGEN (DE); STEFFEN ERTHLE, DORNSTADT (DE); FRANZ SCHWEIGGART, PFAFFENHOFEN (DE)

(73) Assignee: REINZ-DICHTUNGS-GMBH, NEU-ULM (DE)

(21) Appl. No.: 16/641,705

(22) PCT Filed: Aug. 16, 2018
(86) PCT No.: PCT/EP2018/072241

§ 371 Date: Feb. 25, 2020

(30) Foreign Application Priority Data
Aug. 25, 2017 (DE) 20 2017 105 124.2

(51) Int. Cl. F01N 13/10; F01N 13/18; F01N 13/16; F16J 15/08

(52) U.S. Cl. CPC F01N 13/102; F01N 13/1855; F16J 15/0825; F01N 13/16; F01N 13/1827

(57) ABSTRACT

A heat shield for shielding hot regions of a component is described. The component may be an exhaust manifold with a heat shield and also an internal combustion engine with an exhaust manifold or heat shield.

The present invention relates to a heat shield for shielding hot regions of a component, to an exhaust manifold with a heat shield according to the invention, and also to an internal combustion engine with an exhaust manifold or heat shield according to the invention.

Heat shields are used in various fields of application for shielding a component or component region against heat and/or noise by means of insulation, reflection and/or absorption. Designs of heat shields in this case comprise single-layer and multi-layer heat shields. One particularly important branch of industry for such heat shields is the automobile and other vehicle industry. There they are used for example for shielding heat-sensitive components in the engine compartment, the surroundings thereof and the associated exhaust tract, or alternatively for shielding between the exhaust tract and passenger compartment.

Conventionally, such heat shields are three-dimensionally shaped structural components which serve to shield a heat-sensitive region from a heat source. As a rule, such heat shields are fastened to a heat-sensitive or a heat-carrying component, the latter more frequently being the case. Connection takes place in this case at at least one, but preferably at several, locations.

In modern motor vehicles, ever-higher demands are being made on heat shields, this being essentially due to the fact that downsizing in vehicles leads to greater heat generation and frequently also to a closer arrangement of components, which in turn makes heat dissipation more difficult. As a result, heat shields are becoming increasingly important.

In particular in order to avoid convection in impermissible directions, heat shields are often attached such that they extend over regions in which they cross fluid lines. In such case, it is then often necessary for the heat shields themselves to have passage openings through which fluid can pass. In order to prevent unintentional transfer of material at these media throughflow openings, it is necessary to seal off these throughflow openings.

With such conventional heat shields, a plurality of seal layers are used for sealing-off at such passages, which makes the production of the heat shields complex and expensive. In particular, it is necessary to arrange at least one seal layer in each case on either side of the heat shield. Therefore as a rule at least two, but often up to four, active layers, i.e. sealing seal layers, are combined with a heat shield. In this case, e.g. with four active layers, two layers in each case are welded together and then fastened by riveting or clinching on either side of the heat shield. This requires not only high material costs, but also increased manufacturing expense.

Usually the seal layers are thinner than the layers of the heat shield. In such case, premature destruction may occur as a result of for example sliding movements of a heat-carrying component on a thin seal plate which are due to thermal expansion.

The object of the invention is therefore to make available a heat shield which makes available effective, durable and cost-efficient sealing for media throughflow openings. Likewise, an exhaust manifold with a heat shield according to the invention and an internal combustion engine with an exhaust manifold or heat shield according to the invention should be made available.

This object is achieved by the heat shield according to claim 1, and also by the exhaust manifold according to claim 16 and also by the internal combustion engine according to claim 17. Advantageous developments of the heat shield according to the invention are given in the dependent claims.

The heat shield according to the invention now is distinguished in that the heat shield has at least one metallic shielding layer and a single-layer metallic sealing element.

The at least one shielding layer in this case is of such nature that heat transfer from a heat source to a heat-sensitive component can be reduced or prevented by means of the shielding layer.

It is understood that the geometric nature may vary according to the application. In particular, the shielding layer may have a substantially flat form which is shaped at various locations. The shapings in this case may facilitate the fastening of the shielding layer to a counter-component, or alternatively may be similar to the external contour of a heat-carrying component or alternatively of a component which is to be insulated against heat, in particular may be formed at least in portions approximately parallel thereto.

The shielding layer in addition has at least one media throughflow opening, i.e. a passage opening which first and foremost or exclusively is suitable to allow a fluid as medium to pass through. In the context of this invention, a media throughflow opening in a shielding layer is not restricted to a self-contained media throughflow opening. Rather, a media throughflow opening in a shielding layer also comprises such cutouts in a shielding layer which are only partially surrounded by material, i.e. e.g. also indentations in shielding layers.

The one or at least one metallic sealing element has the function, encircling the at least one media throughflow opening of the shielding layer, of achieving a sealing action between a plurality of components adjacent to the heat shield.

In this case, the claim is to be understood such that a plurality of single-layer metallic sealing elements may also be comprised by the heat shield, but at least one individual single-layer metallic sealing element is present.

The sealing element too has at least one media throughflow opening. This throughflow opening is arranged adjacent to the media throughflow opening of the shielding layer in the direction of throughflow of the fluid. In addition, the media throughflow openings are arranged adjacent to each other in a direction perpendicular to the layer plane.

The sealing element is arranged at least in portions on both sides along the inner peripheral edge of the media throughflow opening of the shielding layer. This means that, in an orthogonal projection onto the shielding layer, the sealing element is arranged at least in portions on either side of the peripheral edge of the media throughflow opening of the shielding layer. In other words, along a portion of the contour of the media throughflow opening of the shielding layer, the sealing element is formed on either side of the line formed by the contour. This means that the sealing element, in an orthogonal projection onto the shielding layer, is arranged overlapping with the contour of the inner peripheral edge of the media throughflow opening of the shielding layer.

The sealing element has at least one overlap portion which is arranged overlapping with the shielding layer at least in portions along the inner peripheral edge of the media throughflow opening of the shielding layer.

This overlap portion may serve to position and possibly to fix the sealing element relative to the shielding layer.

Furthermore, the sealing element has a sealing portion which, at least in portions along the inner peripheral edge, is arranged in encircling manner within the media throughflow opening of the shielding layer.

Such a heat shield makes it possible, by means of the sealing element within the media throughflow opening of the shielding layer, to achieve a sealing action, with only one additional layer being necessary in addition to the shielding layer. As a result, a significant reduction in material and weight compared with conventional heat shields with media throughflow openings and a plurality of sealing layers is achieved. Furthermore, the complexity of the unit is reduced and the manufacture and mounting of the heat shield are simplified.

Advantageous embodiments of the heat shield according to the invention comprise embodiments with one, two, three or more than three shielding layers, with the shielding layers possibly being arranged adjacent to each other. In particular, it is possible for one shielding layer on one or both of its two-dimensionally formed surfaces to lie in surface-to-surface contact against one or two surfaces of adjacent shielding layers. In other words, the layer planes of the shielding layers may run, at least in portions, parallel to each other. The layer plane of each of the shielding layers is defined in this case by way of the neutral axis of the shielding layer in the region adjoining the at least one media throughflow opening.

The sealing element is advantageously formed as a two-dimensional component which is provided in portions with shapings. Advantageously, a surface of the shielding layer which is formed over the full surface and a surface of the sealing element, in particular of the overlap portion, which is formed over the full surface are arranged, at least in portions, directly adjacent to each other.

The at least one shielding layer and the sealing element may be connected together outside their media throughflow openings by a positive connection, by a non-positive connection and/or by a material-formed bond. As a result, accurate positioning relative to each other can be ensured and the materials handling prior to the installation of the heat shield is simplified. It is however also possible to provide the fastening such that the at least two elements are connected together, but their final positioning relative to each other only takes place during installation.

It is furthermore possible for the sealing element not to be fixed until the fastening of the heat shield to the adjacent component occurs. In particular with this embodiment, centring aids may be used for fitting.

Advantageously, the sealing element may have one, two, three or more than three overlap portions. An individual completely encircling overlap portion in the installed state may bring about a particularly uniform distribution of stresses and uniform deformation of the adjacent (sealing) regions, as a result of which a particularly beneficial sealing effect can be achieved. However, a plurality of overlap portions may also be present, with each portion being formed only along a partial portion of the peripheral edge of the media throughflow opening of the shielding layer. This embodiment makes it possible to save on material.

Preferably at least one sealing line formed by the sealing portion is arranged in completely encircling manner around the media throughflow opening of the sealing element. This ensures that a complete sealing action is provided in encircling manner.

In particular, it is possible for the sealing portion to run merely in portions along the inner peripheral edge of the media throughflow opening of the shielding layer, but in completely encircling manner within the media throughflow opening of the shielding layer. As a result, a closed sealing line can be formed around the throughflow cross-section of the fluid passing through, but this sealing line does not inevitably have to run fully along the inner peripheral edge of the media throughflow opening of the shielding layer, but may at least in portions be clearly spaced apart therefrom. This may be the case in particular if the media throughflow opening is not circular, but elongate in form, while the sealing line runs in a circle. This may in particular also be the case if the media throughflow opening of the shielding layer is not completely encompassed by the shielding layer, for example in the event that a passage opening (during its manufacture) is formed so close to an edge of the shielding layer that once it has been formed it itself forms part of this edge, for example an indentation in this edge.

The at least one media throughflow opening of the shielding layer and/or of the sealing element may in each case be formed to be in particular circular or oval. They may be formed at any locations of the shielding layer and/or of the sealing element whatsoever.

According to the invention, the media throughflow openings are arranged within the outer peripheral edge of the sealing element. For the shielding layer, it is however also possible for the media throughflow openings to be formed at the edge, i.e. to be formed in such a way that they are not completely surrounded by the layer material of the shielding layer, but themselves form part of the outer peripheral edge of the shielding layer. Preferably a media throughflow opening in a shielding layer in total is encompassed at least over 180°, particularly preferably at least over 270°, by material of the shielding layer. Advantageously, the media throughflow openings are formed in a planar face, so that in this case the edge of a media throughflow opening runs completely within a plane. In this embodiment, the edge of the media throughflow opening does not have any projections or set-back portions in the direction of circulation. This facilitates the sealing-off and also the formation of the throughflow openings per se.

Advantageously, the media throughflow openings are formed in such a way that the centre line of the opening is formed substantially perpendicularly to the layer plane of the shielding layer and/or of the sealing element in the overlap portion surrounding the media throughflow opening. If not defined otherwise, the layer plane here—both for the at least one shielding layer and for the sealing element—designates the neutral axis of the layer in question, or in the case of a heat shield with a plurality of shielding layers the neutral axis yielded for the total of the shielding layers. In particular, in this case the lateral surface of a straight circular cylinder can be formed on the boundary surface of the media throughflow opening of the shielding layer and the shielding layer. With regard to the layer plane of the sealing element, advantageously the neutral axis of the region directly surrounding the media throughflow opening is considered, but not necessarily the regions arranged at a distance therefrom, which may for example have a plane offset thereto in which the major part of the sealing element extends.

It is understood that the media throughflow openings of the sealing element and of the heat shield may be arranged coaxially or with centre lines running parallel to each other.

In one advantageous development of the heat shield, the sealing portion in each case forms a sealing line running along the inner peripheral edge of the media throughflow opening of the shielding layer and/or of the sealing element, which sealing line(s) is/are arranged on different sides of the layer plane of the shielding layer. This means that due to the sealing portion two sealing lines can be formed within the media throughflow opening of the shielding layer, these running at least in portions along the edge of the media throughflow opening of the shielding layer.

Furthermore, the two sealing lines are advantageously also arranged on different sides of the layer plane. In other words, one sealing line may run above and one sealing line below the layer plane of the sealing element and/or of the layer plane of the shielding layer. In the fitted state, thus in particular in each case one sealing line may be formed on each of the two surfaces of the heat shield.

This makes it possible to form two different sealing lines, with a single sealing element, hence by a single active layer, so that the media throughflow openings of the heat shield on both surfaces of the heat shield are sealed in encircling manner.

Advantageously, a first sealing line is formed at a contact zone between a region of a first adjacent component and a first region of the sealing portion, and a second sealing line at a zone of contact between a region of a second adjacent component and a second region of the sealing portion. The sealing lines are advantageously arranged within the media throughflow opening of the shielding layer.

In particular, embodiments of the heat shield in which the adjacent components, in an orthogonal projection onto the layer plane of the sealing element, are formed completely or partially overlapping with the sealing portion are advantageous.

Advantageously, the structure of the sealing portion in the installed state presses the sealing portion at least in portions against the first and the second component, so that the sealing lines form.

It is also possible for not only two, but three, four or more than four sealing lines to be formed on one media throughflow opening. For example, a plurality of sealing lines running in parallel to each other may be formed per side. As a result, the sealing behaviour can be improved. In particular, it is possible for dirt particles or residues of the fluid which are deposited at a point of contact of the sealing portion and the first or second adjacent component, hence on a sealing line, to impair or nullify the sealing action. In this case, the tightness can be ensured by one of the sealing lines which run in parallel.

With regard to the further configuration of the invention, the sealing portion has a transition portion spaced apart from but adjacent to the overlap portion, which transition portion extends through the media throughflow opening of the shielding layer. For example, viewed in a section parallel to the centre line of the media throughflow opening, in particular a radial section through the media throughflow opening, the sealing portion may have between its radially inner and radially outer end, at least in portions, a transition portion which is arranged spaced apart from but adjacent to the overlap portion. In this embodiment, the sealing portion therefore has a transition portion which is arranged between a radially inner end region and a radially outer end region of the sealing portion.

Viewed in this section, the sealing portion (in each case on either side of the axis) may run along a main line, the starting point of which forms the radially inner point of the sealing portion and the end point of which forms the radially outer point of the sealing portion. Between the starting point and end point, the course of the main line may be composed of a plurality of line portions connected at junction points, with each line portion being in the form of a straight line, a circular arc or a transition curve. The transition portion may be composed of one or more such line portions. In particular, the transition portion may be composed of an individual straight line or of a plurality of straight lines. The transition portion may in particular furthermore be composed of a straight line portion, in front of which and behind which in each case one or more circular arcs or transition curves are arranged. Likewise, the transition portion may consist exclusively of circular arcs and transition curves.

The transition portion may pass completely or only through part of the media throughflow opening in the axial direction.

Advantageously, the course of the main line of the transition portion rises or falls monotonically from the starting point to the end point.

The line portions advantageously have a constant thickness, i.e. extent in the direction perpendicular to the line portion, with a tangent being laid in curved regions at the point considered. The thickness may however also vary in the course from the starting point to the end point. In particular, the thickness may change in the region of marked changes in curvature.

It is understood that the sealing portion may be formed rotationally symmetrically around the media throughflow opening of the sealing element.

In one advantageous development, the sealing portion in cross-section in the direction pointing from the overlap portion to the passage has in succession an outer portion, a middle portion and an inner portion, which merge into one another by way of two successive breaks directed in opposite directions and in each case have a first, non-curved, straight portion. The breaks in this case are to be understood as curved breaks.

It is recommended that in the installed state of the heat shield the inner portion should lie in surface-to-surface contact against the first adjacent component and the outer portion should lie in surface-to-surface contact against the second adjacent component, or the outer portion should lie in surface-to-surface contact against the first adjacent component and the inner portion should lie in surface-to-surface contact against the second adjacent component.

Preferably in one configuration of the invention the sealing element consists of a metal sheet with a tensile strength of at least 1000 N/mm², in particular therefore of a spring-hard material, for example a spring-hard steel or alternatively a nickel-based alloy. The sealing element may in this case be uncoated, but it may also be coated at least on one side at least in portions, in particular with a coating for reducing cold leakage. Advantageously, the sealing element is however coated on both surfaces at least in the region of the sealing lines.

Furthermore preferably, in one configuration of the invention at least one of the at least one shielding layer(s), preferably all of the at least one shielding layer(s), consist(s) of a metal sheet with a tensile strength of less than 800 N/mm². Advantageously in particular steel, hot-dip aluminised steel, aluminium-plated steel or high-grade steel are used as materials for the shielding layers. In addition to unstructured material, advantageously, in particular in some of the layers when a plurality of shielding layers are being used, also material which at least in portions is perforated or which at least in portions is dimpled can be used. Advantageously non-metallic insulating material, in particular fibre-based material, may also be used in particular between two metallic shielding layers.

It is recommended that the shielding layer have at least one fastening region for screw holes for fastening the heat shield to a component. In this case, both substantially tolerance-free positioning, for example exclusively by means of round holes, and also fitting at least partially by means of elongated holes, are possible, so that compensation of expansions/contractions which are due to temperature is possible during operation. Advantageously, the fastening regions are arranged within the overlap portion of sealing element and at least one shielding layer. In the case of large heat shields, in particular those with regions of the at least one shielding layer which run at an angle relative to the overlap portion, the at least one fastening region may also be a region bent over at an angle, optionally at a right-angle, out of the layer plane which has screw holes for fastening to a component. Preferably, however, such a fastening region is also combined with at least one fastening region within the overlap portion, so that not all the fastening regions have to lie in the same plane or in planes which are parallel to each other.

In one advantageous development, the fastening region is located adjacent to the outer peripheral edge of the shielding layer. It is however likewise possible for the fastening region to be arranged not adjacent to the outer peripheral edge, i.e. centrally on the shielding layer. The fastening region may have one, two, three or more than three screw holes.

Advantageously, the total of the thicknesses of the at least one shielding layer D_{A} relative to the thickness of the sealing element D_{D} is formed in such a way that 10≥D_{A}/D_{D}≥1.5, preferably 8 D_{A}/D_{D}≥1.8, particularly preferably 6 D_{A}/D_{D}≥2. The thickness of the sealing element in this case is to be understood as the material thickness, i.e. the local additional thickness in the sealing portion is not taken into account as well.

In one further advantageous development, the at least one shielding layer and the sealing element in each case have a plurality of media throughflow openings, with in each case one media throughflow opening of the at least one shielding layer and one media throughflow opening of the sealing element being arranged adjacent to each other in the direction of throughflow. Advantageously, the media throughflow openings are arranged in such a way that preferably in each case one pair consisting of a media throughflow opening of the shielding layer and of a media throughflow opening of the sealing element are arranged in each case adjacent to each other. It is also possible for a plurality of media throughflow openings of the sealing element to be arranged adjacent to a media throughflow opening of the shielding layer.

Advantageously, the diameters of the media throughflow openings of the shielding layer are at least approximately of the same size: this likewise applies to the media throughflow openings of the sealing element.

In one further advantageous development, the centre lines of all the or some of the media throughflow openings intersect a line which runs perpendicularly to the axes. In this embodiment, the media throughflow openings are therefore arranged along a straight line.

Furthermore preferably, the at least one shielding layer is undivided in its surface plane and the sealing element consists of a single element. What is advantageous about this embodiment is in particular that fitting of the sealing element on the shielding layer can also be made possible with few fastening points.

Alternatively, it is however likewise possible for the at least one shielding layer to be undivided in its surface plane and for the sealing element to consist of a plurality of elements arranged next to one another in the face of the sealing element, each element having at least one media throughflow opening. This embodiment can preferably be used in particular if the distance between the media throughflow openings of the shielding layer is relatively large.

All the embodiments may be formed symmetrically about the centre line of a media throughflow opening.

The object described first hereinbefore is in addition achieved by an exhaust manifold with a heat shield according to the invention. In such case, preferably the overlap portion is arranged on the side of the heat shield remote from the exhaust manifold, so that the sealing element is predominantly spaced apart from the exhaust manifold. In another embodiment, the overlap portion is arranged on the side of the heat shield facing the exhaust manifold, but has an additional anti-friction coating. In this manner, the exhaust manifold is prevented from damaging the heat shield or its surface, in particular the surface of the sealing element, in the event of expansions and shrinkage which are due to temperature, when it slides.

Likewise, the object described is achieved by an internal combustion engine with an exhaust manifold according to the invention or a heat shield according to the invention.

Below, several examples of heat shields according to the invention are given, with identical or similar elements being provided with identical or similar reference numerals. The description thereof may therefore possibly not be repeated. Furthermore, the following examples of embodiment contain a large number of advantageous developments and features which however are also suitable as such per se for developing the present invention without being considered in combination with the further advantageous features of the respective embodiment. Combinations of individual features of different examples of embodiment are also readily possible as advantageous developments.

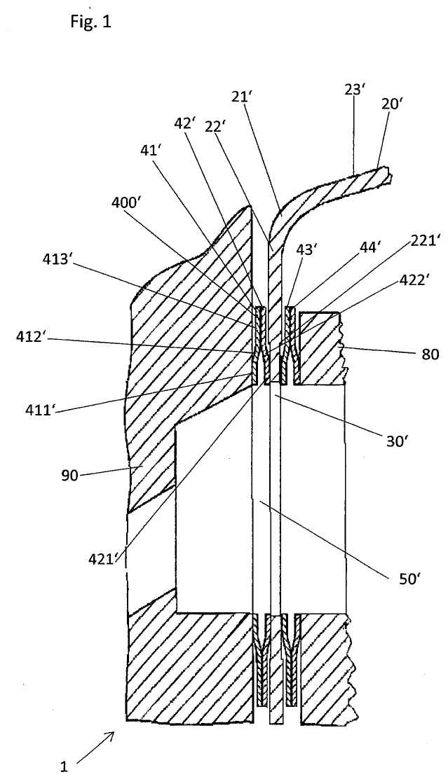

FIG. 1 is a sectional view through a heat shield with passage opening and seal in the prior art;

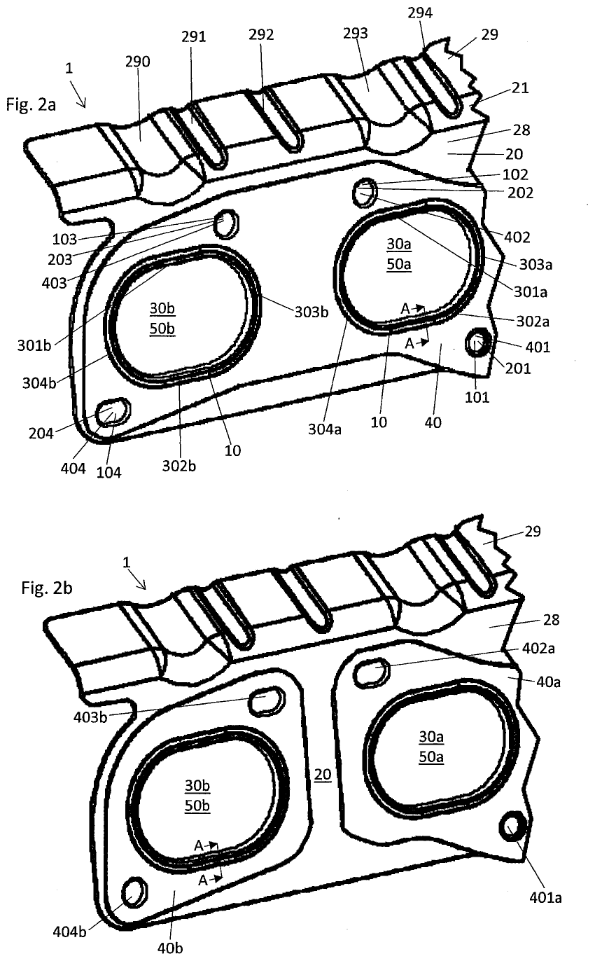

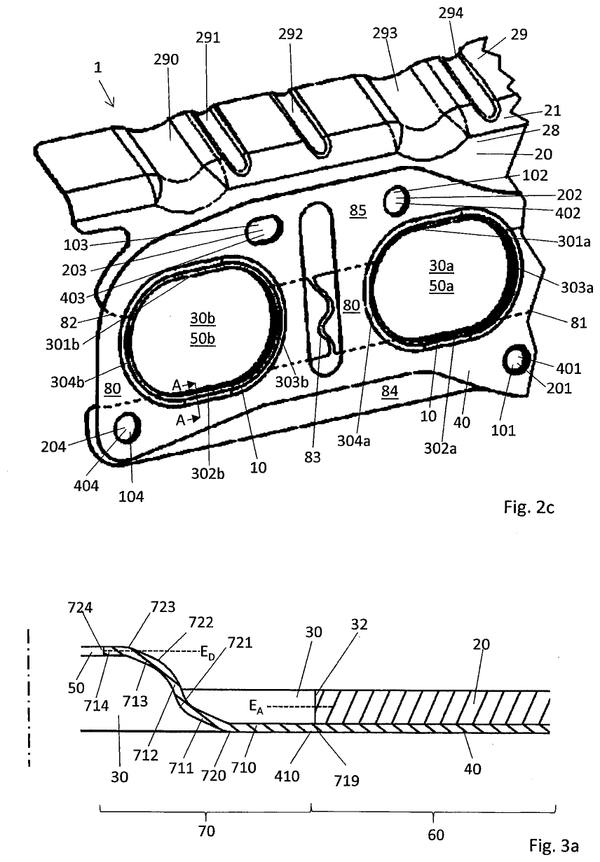

FIG. 2a is a top view of a heat shield according to the invention with a sealing element;

FIG. 2b is a top view of a further heat shield according to the invention with two sealing elements;

FIG. 2c is a top view of a further heat shield according to the Invention with a sealing element;

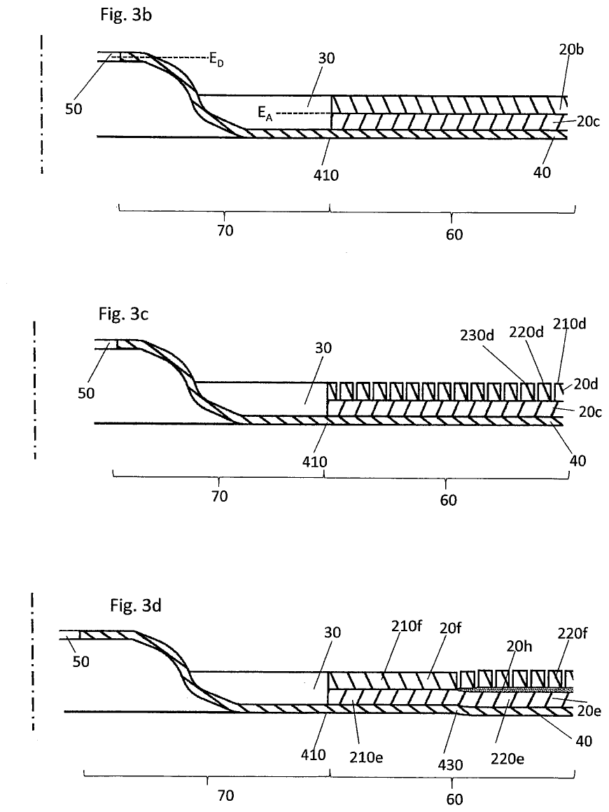

FIGS. 3a to 3d are sectional views through further heat shields according to the invention with different embodiments of shielding layers;

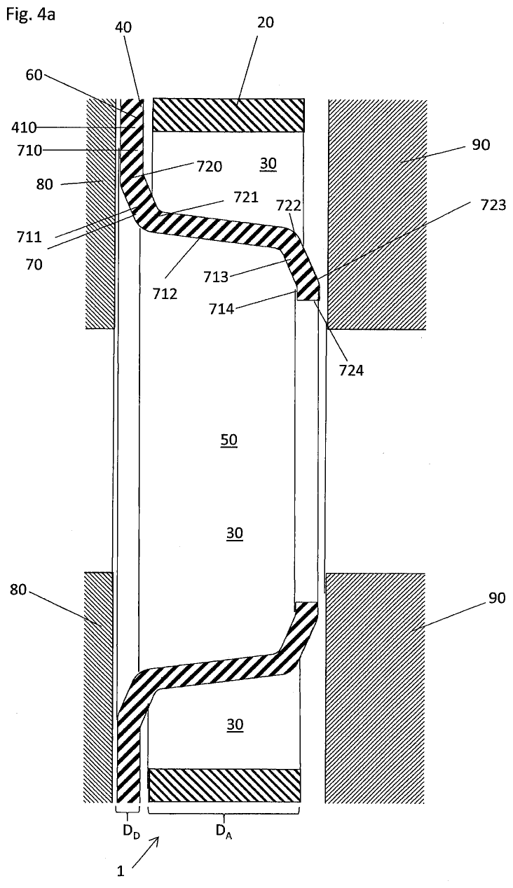

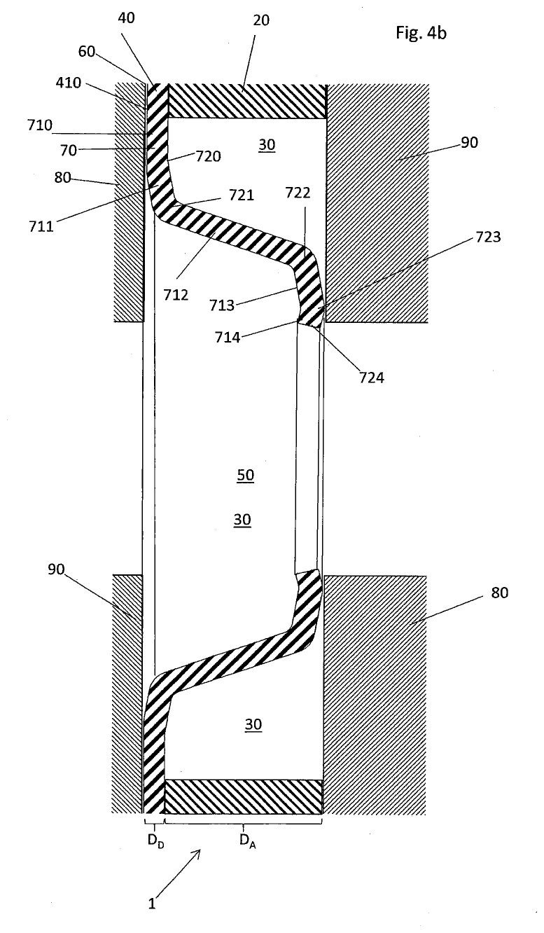

FIG. 4a is a diagrammatic sectional view through a further heat shield according to the invention prior to the final installed situation;

FIG. 4b is a diagrammatic sectional view through the heat shield according to the invention of FIG. 4a in the compressed state.

FIG. 1 shows a heat shield 1 with passage opening and a seal encircling this passage opening according to the prior art in section through the passage opening.

A shielding layer 20′ is arranged between a first counter-component 80 and a second counter-component 90. The shielding layer 20′ is formed substantially flat and has a rounded-off break 21′ at which the shielding layer 20′, viewed in cross-section, is deformed through an angle of approximately 80°. As a result, a portion 22′ of the shielding layer 20′ which runs parallel to the surfaces of the counter-components 80, 90 and also a portion 23′ which runs offset relative to these surfaces is formed. The shielding layer has a passage opening 30′ in its portion 22′ which runs parallel to the surfaces of the counter-components 80, 90.

The counter-components 80, 90 also have a passage opening in each case. The passage opening of the counter-components 80, 90 and of the shielding layer 20′ are all arranged adjacent to each other. The centre line of the passage opening of the first counter-component 80 and also the centre line of the passage opening 30′ of the shielding layer 20′ are formed coaxially, with the diameter of the shielding layer 20′ being greater by a very slight amount than the diameter of the media throughflow opening of the first counter-component 80. The passage opening of the first counter-component 80 in the portion illustrated is formed rotationally symmetrically, so that the opening is in the form of a straight circular cylinder.

The diameter of the passage opening of the second counter-component 90 is formed directly adjacent to the passage opening 30′ of the shielding layer 20′ in such a way that the diameter is identical to the diameter of the first counter-component 80. However, the passage opening of the second counter-component 90 is formed not rotationally symmetrically in the vicinity of the passage opening 30′ of the shielding layer, so that the lateral surface of the passage opening of the second counter-component 90 in the section illustrated exhibits two lines running not parallel to each other.

In order to prevent inadvertent transfer of material between the surface of the first counter-component 80 and the surface of the shielding layer 20′ which is adjacent thereto, and also between the surface of the second counter-component 90 and the surface of the shielding layer 20′ which is adjacent thereto, a sealing element 400′ according to the prior art with a media throughflow opening 50′ is introduced between the respective surfaces.

This sealing element 400′ consists of four separate individual active layers 41′, 42′, 43′, 44′. Here, two of these layers 41′, 42′, 43′, 44′ in each case are arranged on one side of the shielding layer 20′. In this case, the layers 43′ and 44′ are located between the first counter-component 80 and the shielding layer 20′. Between the second counter-component 90 and the shielding layer 20′ are located the layers 41′ and 42′. These four layers 41′, 42′, 43′, 44′ are arranged in the vicinity of the passage openings and rotationally symmetrically about the centre line of the passage openings of the shielding layer 20′ and counter-component 80. The layers 41′, 42′, 43′, 44′ in each case also have a passage opening, which are arranged substantially coaxially to the passage openings of the first counter-component 80 and also of the shielding layer 20′.

The first layer 41′ now—like each of the four layers—in the immediate vicinity of its passage opening has an inner annular portion 411′ formed as a ring disc, the surface of which portion in the non-compressed state, i.e. in the non-screwed state, runs parallel to the layer plane of the portion 22′ of the shielding layer 20′. The ring-disc-shaped portion 411′ continues at a location into a connection region 412′. This connection region 412′ in turn continues in the radially outer direction into a further outer ring-disc-shaped region 413′. The outer ring-disc-shaped region 413′ is likewise formed parallel to the layer plane of the portion 22′ of the shielding layer 20′. This is the case both in the screwed and in the non-screwed state. The connection region 412′ runs at an incline compared with its two adjacent ring-disc-shaped regions 411′, 413′. Viewed in cross-section, therefore, a half-bead shape is formed in each of the four layers 41′ to 44′. The connection region 412′ and also the inner and outer ring-disc-shaped regions 411′, 413′ are formed comparably in the other three layers 42′, 43′, 44′.

The layer 41′ and the layer 42′ in the non-compressed state are arranged lying on one another on their outer ring-disc-shaped regions 413′. The connection regions 412′, 422′ of the two layers run mirror-symmetrically to each other in the direction pointing towards the passage opening and away from each other towards the passage opening. This in cross-section yields a Y-shaped profile formed from the portions 411′, 412′, 421′, 422′ of the two layers 41′, 42′. The splayed region which is formed by the inner annular portions 411′, 421′ and by the connection regions 412′, 422′ in this case is arranged directly adjacent to the passage opening.

The first layer 41′ is formed mirror-symmetrically to the second layer 42′, with the plane of symmetry running along the region of contact of the first and second layer 41′, 42′. Furthermore, the combination of first and second layer 41′, 42′ is formed mirror-symmetrically to the combination of third and fourth layer 43′, 44′, the plane of symmetry being formed by the layer plane 22′ of the non-bent region 22′ of the shielding layer 20′.

The shielding layer 20′ in the vicinity of the splayed region 411′ has embossing in encircling manner on both its surfaces, so that a step 221′ adjacent to the passage opening 30′ of the shielding layer 20′ is yielded on both surfaces.

In the installed state, that region of the shielding layer 20′ which is not cut out, the inner annular portions 411′, 421′ of the layers 41′, 42′ and also the further counter-component are pressed against each other. The splayed region of the Y-shaped profile in this case is likewise partially compressed, with the splayed region acting as a spring. In this case, the Y-shaped region lies partially in the embossed area of the shielding layer 20′ which forms the step 221′, so that the splayed region is not completely compressed. The sealing between the shielding layer 20′ and the second counter-component 90 is then guaranteed by the Y-shaped region lying against the second counter-component 90 and shielding layer 20′.

The layers 43′ and also 44′ are formed in the same way to form a Y-shaped region, but between the shielding layer 20′ and the first counter-component 80. The cut face of the first layer 41′ in this case coincides with the cut face of the third layer 43′, and the cut face of the second layer 42′ coincides with the cut face of the fourth layer 44′. Both layer pairs 41′-42′ and 43′-44′ thus form half-bead stacks.

FIG. 2a shows a top view of a heat shield 1 according to the invention.

The heat shield has a metallic shielding layer 20 for shielding heat-sensitive components, which here is likewise formed flat in portions. The shielding layer 20 which serves for heat insulation can be roughly divided into an evenly formed first region 28 and into a second region 29 running approximately at right-angles thereto, which second region has various shapings 290, 291, 292, 293, 294 for reinforcement and as an installation space for further components, for instance for lines.

The first region 28 and the second region 29 are connected together by way of a rounded-off break region 21. The first region has two media throughflow openings 30a, 30b through which at least one fluid can be carried. The openings 30a, 30b are formed roundish, with the external contour, i.e. the periphery of the media throughflow openings 30a, 30b, being composed in each case of two parallel portions 301a, 302a, 301b, 302b which are located opposite each other and of two circular-arc portions 303a, 304a, 303b, 304b which are located opposite each other.

Lying in surface-to-surface contact on the first portion 28 there is arranged a single-layer metallic sealing element 40. This sealing element 40 likewise has media throughflow openings 50a, 50b, with media throughflow opening 50a being arranged overlaid with throughflow opening 30a of the first region and media throughflow opening 50b being arranged overlaid with throughflow opening 30b of the first region. Encircling the media throughflow openings 30a, 30b, 50a, 50b, the edges 10 of the sealing portion 70 (cf. FIG. 3a ff.) are illustrated only roughly in a top view. More detailed illustrations are made available in subsequent figures.

To fasten the shielding layer 20 and sealing element 40, four screw holes 101, 102, 103, 104 are provided which are arranged in the non-immediate vicinity of the media throughflow openings 30a, 30b, 50a, 50b, each screw hole in each case being in the form of an opening in the shielding layer 20 and an opening in the sealing element 40. Thus the first screw hole 101 is in the form of an opening 201 in the shielding layer and of an opening 401 in the sealing element. Correspondingly, the other three screw holes 102, 103, 104 are formed as openings 202, 402, 203, 403, 204, 404. Openings 201, 401, 202, 402 are arranged adjacent to the media throughflow openings 30a, 50a and are arranged approximately located opposite each other relative to the centre line of the media throughflow openings 30a, 50a. The openings 203, 403, 204, 404 are arranged adjacent to media throughflow openings 30b, 50b and are likewise arranged approximately located opposite each other relative to the centre lines of the media throughflow openings 30b, 50b.

FIG. 2b shows a top view of a further heat shield according to the invention. The embodiment differs from the embodiment in FIG. 2a in that the sealing element is divided between the media throughflow openings 30b, 50b on one hand and 30a, 50a on the other hand. As a result, therefore, two different single-layer sealing elements 40a, 40b are present, of which the first sealing element 40a has the first media throughflow openings 30a, 50a and also two fastening points in the form of first screw holes 401a, 402a, and of which the second sealing element 40b has the second media throughflow openings 30b, 50b and also two fastening points in the form of second screw holes 401b, 402b.

FIG. 2c shows a top view of a further heat shield according to the invention. Here the sealing element 40 as in FIG. 2a consists of a single part. The shielding layer 20 too is formed in one part and single-layer. However, the shielding layer 20 has cutouts 80 to save material and weight. To this end, two main portions 84, 85 of the shielding layer 20 are connected together in one piece by way of a corrugated land 83. The corrugated land 83 can be seen particularly clearly through a cutout in the face of the sealing element 40. The edges 81 and 82 of the main portions 84 or 85 respectively point to each other and delimit the cutouts in portions. They at the same time in portions form the inner edge of the media throughflow openings 30a, 30b. Whereas the edges 10 of the sealing element completely surround the media throughflow openings 50a, 50b, the media throughflow openings 30a, 30b are therefore surrounded only incompletely by material of the shielding layer 20. This may however suffice both for a sufficient sealing action and for sufficient heat shielding. FIGS. 3a to 3d show heat shields 1 according to the invention in sectional views, the section in each case running parallel to the centre line of the media throughflow openings 30, 50 for example along the respective line A-A.

In FIG. 3a there is arranged a metallic shielding layer 20 with a media throughflow opening 30, the layer plane of which is designated E_{A}. This metallic shielding layer 20 serves not only to protect a heat-sensitive component, but at the same time fulfils the function of protection against compression in the fitted state. This will be discussed in greater detail in the context of FIGS. 4a and 4b.

Directly adjacent to the shielding layer 20 there is arranged a single-layer metallic sealing element 40, the layer plane of which is designated E_{D}. This sealing element 40 comprises an overlap portion 60, which in a top view of the layer plane of the shielding layer 20 is arranged overlaid with, i.e. behind, the shielding layer 20.

Furthermore, the sealing element 40 comprises a sealing portion 70 which in a top view of the layer plane is arranged not overlapping with the shielding layer 20, but is arranged within the media throughflow opening 30 of the shielding layer 20. The point of contact 410 of the overlap portion 60 and sealing portion 70 in a top view of the layer plane of the shielding layer 20 is arranged overlaid with the inner peripheral edge 32 of the media throughflow opening 30 of the shielding layer 20. In such case it should be considered that the media throughflow opening 30 in the shielding layer 20 also expands into regions which are covered by the sealing element 40, so that no flow of medium is possible in these edge regions, as can be seen in the left-hand region of FIG. 3a.

In the sectional view, the sealing portion 70 runs along a main line, the starting point of which forms the radially innermost point 724 of the sealing portion 70, i.e. the inner peripheral edge 724 of the media throughflow opening 50 of the sealing element 40, and the end point of which forms the radially outermost point 719, which corresponds to the point of contact 410 of the overlap portion 60 and sealing portion 70. In the direction pointing from the end point to the starting point, the sealing portion is composed of a plurality of successive line portions 710-714, with in each case two adjacent line portions 710-714 being connected together by a junction point 720-723. Starting from the end point 719, the sealing portion 70 initially continues parallel to the layer plane of the shielding layer 20 in the direction of the centre line of the media throughflow opening 30 of the shielding layer 20. From there there continues a further straight line portion 711 which runs at an angle of approx. 10°-20° relative to the layer plane of the shielding layer 20 if angled in a direction pointing to the shielding layer 20, i.e. the second straight line portion, relative to the first straight line portion, is turned from outside inwards about the end of the first line portion to the right (in a clockwise direction). Behind this there joins a further straight line portion 712 which runs at an angle of approx. 50°-60° relative to the layer plane of the shielding layer 20. This line portion 712 individually or together with line portion 711 forms a transition portion which extends through the media throughflow opening 30 of the shielding layer 20. This transition portion is arranged between a radially inner end region, which is formed by the line portion 714, and a radially outer end region, which is formed by the line portion 710.

Behind the line portion 712 there is arranged a further straight line portion 713 which is arranged at an angle of approx. 10°-20° relative to the layer plane of the shielding layer 20. The last line portion 714, which contacts the starting point 724 of the directrix, is likewise formed straight upon being turned from outside inwards to the left about the end point of the penultimate line portion 713, as a result of which the last line portion 714 in turn runs parallel to the layer plane of the shielding layer 20.

The line portions 710-714 of the sealing portion 70 have a virtually identical thickness, i.e. material thickness. The radially innermost line portion 714 and radially outermost line portion 710 of the sealing portion 70 are in each case arranged parallel to the layer plane of the shielding layer 20, with one of these line portions being arranged on one of the two sides of the shielding layer 20 in each case. In other words, in the non-compressed state shown one of these two line portions 714, 710 is arranged above and one below the shielding layer 20.

The sealing portion 70 runs at least in portions along the inner peripheral edge 32 of the media throughflow opening 30 of the shielding layer 20. It runs in encircling manner within the media throughflow opening 30 of the shielding layer 20.

If then counter-components 80, 90 are mounted on either side of the heat shield 1 according to the invention, the sealing portion 70 is deformed, with at least the radially innermost line portion 714 or the junction point 723 on one hand and also the radially outermost line portion 710 or the junction point 720 of the sealing portion 70 on the other hand contacting in each case one of the counter-components 80, 90. As a result, encircling sealing lines are formed. FIGS. 4a and 4b describe this installed situation in greater detail.

FIG. 3b illustrates a further heat shield 1 according to the invention in a sectional view. The embodiment illustrated here differs from the one in FIG. 3a in that instead of one shielding layer 20 two thinner shielding layers 20b, 20c of equal thickness are formed, which are arranged parallel to each other and directly adjacent to each other. A first shielding layer 20c in this case is arranged directly adjacent to the overlap portion 60, and a second shielding layer 20b is arranged spaced apart from the overlap portion 60. The total thickness of both shielding layers yields the same layer thickness in total as the individual shielding layer 20 illustrated in FIG. 3a. The cross-sectional area of the individual shielding layer 20 of FIG. 3a which is illustrated in section coincides with the cross-sectional area of the two shielding layers 20b, 20c of FIG. 3b.

FIG. 3c illustrates a further heat shield 1 according to the invention in a sectional view. The embodiment illustrated in FIG. 3c likewise has two thinner shielding layers 20c, 20d. The embodiment differs from the one in FIG. 3b in that the second shielding layer 20d which is arranged not directly adjacent to the overlap portion 60, at least in the cross-section illustrated, is formed with perforations extending through the entire thickness of the shielding layer 20d, so that viewed in a sectional view cross-sectional areas 210d, 220d, 230d, . . . are formed which do not have any common points of contact with each other in the section plane. The perforations serve for improved absorption of sound in the heat shield 1 and are therefore located on that surface of the heat shield 1 which faces a noise source.

FIG. 3d illustrates a further heat shield 1 according to the invention in a sectional view. In this embodiment, the first shielding layer 20e arranged directly adjacent to the overlap portion 60 is formed similarly to the shielding layer in the preceding two embodiments. Unlike the preceding examples, this shielding layer 20e however has an offset 430, so that two portions 210e, 220e running parallel to each other are formed. The first one of these portions 210e runs radially on the inside and, as in the preceding two examples of embodiment, is formed half as thick as the example of embodiment in FIG. 3a. The radially outer portion 220e is formed offset in the direction of the sealing element 40.

Similarly to the preceding two examples of embodiment, a second shielding layer 20f is formed, which here however is divided into a radially inner portion 210f and a radially outer portion 220f, with the two portions contacting each other [when] projected onto the layer plane of the sealing element 40 at the location of the offset 430. The radially outer portion 220f runs perpendicularly to the layer plane in the direction pointing away from the sealing element, offset relative to the radially inner portion 210f of the second shielding layer 20f.

The portion 210f of this second shielding layer which is formed radially on the inside, identically to the example of embodiment of FIG. 3b, is formed directly adjacent to the first shielding layer 20e and has the same thickness as the latter.

The radially outer portion 220f is formed similarly to the second shielding layer 20d of the example of embodiment in FIG. 3c, which is arranged not directly adjacent to the sealing element 40 in the overlap portion 60, i.e. with perforations. The radially outer portion 220f of the second shielding layer is not directly adjacent to the radially outer portion 220e of the first shielding layer, since a third shielding layer 20h is arranged between the radially outer portion 220e of the first shielding layer and the radially outer portion 220f of the second shielding layer. This third shielding layer 20h is formed far thinner than the other two shielding layer regions 20e, 20f and consists of a fibre-based material which in interaction with the perforations is particularly well suited for acoustic absorption.

Overall, therefore, the radially outer portion has a larger cross-sectional area, because in the radially outer region three sealing layers [sic] 20f, 20h, 20e are arranged parallel to each other. The radially inner portion has a smaller cross-sectional area, because only two of these three sealing layers are arranged here, namely the outer layers 20e, 20f. These two outer layers have the same thickness, i.e. material thickness, in the radially inner and in the radially outer region.

The example of embodiment of FIG. 3d differs further from the preceding examples of embodiment in that the sealing portion 70 protrudes further into the media throughflow opening 50. This makes it possible to make the point 724 of the sealing portion which is radially innermost in cross-section in the installed state come to lie on the component adjoining the sealing element 40 in the overlap portion 60, and thus to provide an additional sealing line.

FIG. 4a and FIG. 4b show a further heat shield 1 according to the invention with adjacent counter-components 80, 90 in a schematic sectional view, with the section running through the media throughflow opening 30 of the metallic shielding layer 20 and through the media throughflow opening 50 of the single-layer metallic sealing element 40. In this illustration, in addition the thicknesses D_{D} and D_{A} of the sealing element and shielding layer are given. FIG. 4a in this case represents a non-compressed state, i.e. a state prior to the final screwing of the components, while FIG. 4b represents a compressed state, i.e. a state in the fully screwed and installed state.

On both two-dimensional sides of the heat shield 1 according to the invention, i.e. in the forward direction and in the opposite direction to the forward direction of the media throughflow openings, there are arranged a first counter-component 80 and a second counter-component 90. The counter-components 80, 90, the shielding layer 20 and the metallic sealing element 40 all have in each case a media throughflow opening which are in each case arranged coaxially with each other. All the media throughflow openings have a circular throughflow cross-section. In this case, the media throughflow openings of the counter-components 80, 90 have the smallest diameter; the media throughflow opening 30 of the metallic shielding layer 20 has the largest diameter; the diameter of the media throughflow opening 50 of the metallic sealing element 40 lies between them.

The centre line of the media throughflow openings is arranged perpendicularly to the layer plane of the shielding layer, and thus perpendicularly to the surfaces of the individual components (counter-components 80, 90, shielding layer 20, sealing element 40) which contact each other in each case.

In the sectional view, the cut faces of the counter-components 80, 90 and of the metallic shielding layer 40 are therefore formed rectangular in each case, so that in FIG. 4 in each case a rectangular cut face is formed on either side of the media throughflow openings by the first counter-component 80, the metallic shielding layer 20 and the second counter-component 90.

The single-layer metallic sealing element 40 has an overlap portion 60 between the first counter-component 80 and the metallic shielding layer 20. Furthermore, the single-layer metallic sealing element 40 has a sealing portion 70 which contacts the overlap portion 60 at a butting point 410. Starting from this butting point 410, the sealing portion 70 extends in the direction of the media throughflow openings. The course of the sealing portion 70 in this case is formed substantially by five straight, successive line portions 710-714, with two adjacent line portions in each case meeting at a point of contact 720-723. The radially innermost region of the sealing portion 70 is marked, i.e. limited, by the starting point 724, and the radially outermost region 710 by the butting point 410 in the radial direction. Viewed from the starting point 724 towards the butting point 410, the first line portion 714 is the shortest; the second, fourth and fifth line portions 713, 711, 710 are of approximately the same length; the longest line portion here, unlike in FIGS. 3a to 3d, is the third line portion 712, which in total is approximately the length of the other four line portions 714, 713, 711, 710. This third line portion 712 may also be referred to as “transition portion”. In the direction pointing from the starting point 724 to the butting point 410, the second and third line portions are bent to the left compared with the preceding line portion, whereas the fourth and fifth line portions are angled to the right relative to the preceding line portion in each case.

In FIG. 4a, between two adjacent components in each case, i.e. between in each case one adjacent pair of counter-components 80, 90, shielding layer 20 and metallic sealing element 40, a gap is arranged which comes about by the components not yet being in the final installed state, i.e. screwed.

In the non-screwed state, relative to the layer plane of the shielding layer 20, the second line portion 713 and the fourth line portion 711 are at approximately the same angle; the first line portion 714 and the fifth line portion 710 run parallel to the layer plane of the shielding layer 20.

The single-layer metallic sealing element 40 in the idealised illustrated portion does not contact any further components 80, 90, 20. Furthermore, the sealing portion 70 in a top view of the layer plane of the metallic shielding layer 20 does not project into the media throughflow openings of the counter-components 80, 90.

In FIG. 4b, the components are illustrated in the final installed state, which is why there is no gap between two components which are adjacent to each other in each case.

One further essential difference from FIG. 4a is due to the fact that the metallic sealing element 40 in FIG. 4b is deformed by the clamping force resulting from the screwing operation. Because the components which are adjacent in each case (counter-components 80, 90, shielding layer 20, sealing element 40) in the installed state move closer to each other, the sealing portion 70 of the sealing element 40 is deformed. In particular, deformation of the sealing portion 70 occurs in the direction pointing radially to the centre line of the media throughflow openings, because the structure of the sealing portion 70 is stressed by the second counter-component 90. As a result, the angles of the individual line portions 710-714 relative to the layer plane of the shielding layer 20 become flatter.

Due to the deformation, in particular due to the angles of the individual line portions 710-714 relative to the layer plane of the shielding layer which have become flatter, the sealing portion on its radially inner regions 714 in a top view of the layer plane of the metallic shielding layer 20 protrudes into the media throughflow opening of the first and second counter-components 80, 90.

Furthermore, in the installed state the single-layer sealing element 40 contacts the first counter-component 80 and the second counter-component 90. The area of contact with the first counter-component 80 is formed in the overlap portion 60 and also in the region of the sealing portion 70 directly adjacent to the overlap portion 60, which region forms the radially outermost line portion 710 of the sealing portion 70 of the sealing element 40. With a corresponding design, in the deflected state the line portion 711 may also lie in surface-to-surface contact. The area of contact with the second counter-component 90 is produced in the point of contact 723 between the radially innermost two line portions 714, 713 of the sealing portion 70. During operation, in particular in the event of vibrations, the area of contact may change.

The extent of the deformation is limited by the metallic shielding layer 20. For because the shielding layer 20 and the overlap portion 60 are arranged between the counter-components 80, 90, a minimum distance between the counter-components 80, 90 is ensured in the installed state too. The metallic shielding layer 20 thus serves as protection against compression for the sealing portion 70.

1-17. (canceled)

18. A heat shield for shielding hot regions of a component, comprising:
at least one metallic shielding layer and
a single-layer metallic sealing element,
wherein the shielding layer and the sealing element in each case have at least one media throughflow opening, wherein the media throughflow openings are arranged adjacent to each other in the direction of throughflow,
wherein the sealing element is arranged at least in portions on both sides along the inner peripheral edge of the media throughflow opening of the shielding layer and has at least one overlap portion which is arranged overlapping with the shielding layer at least in portions along the inner peripheral edge of the media throughflow opening of the shielding layer and has a sealing portion which is arranged in encircling manner within the media throughflow opening of the shielding layer at least in portions along the inner peripheral edge.

19. The heat shield according to the claim 18, wherein the sealing portion in each case forms a sealing line running along the inner peripheral edge of the media throughflow opening of the shielding layer and/or of the sealing element, which sealing lines are arranged on different sides of the layer plane (E_{A}) of the shielding layer.

20. The heat shield according to claim 18, wherein the sealing portion has a transition portion spaced apart from but adjacent to the overlap portion, which transition portion extends through the media throughflow opening of the shielding layer.

21. The heat shield according to claim 18, wherein the sealing portion in cross-section in the direction pointing from the overlap portion to the passage has in succession an outer portion, a middle portion and an inner portion which merge into one another by way of two successive breaks directed in opposite directions, and in each case have a first, non-curved, straight portion.

22. The heat shield according to claim 21, wherein in the installed state of the heat shield the inner portion lies in surface-to-surface contact against a first adjacent component and the outer portion lies in surface-to-surface contact against a second adjacent component,
or
the outer portion lies in surface-to-surface contact against a first adjacent component and the inner portion lies in surface-to-surface contact against a second adjacent component.

23. The heat shield according to claim 18, wherein at least one sealing line formed by the sealing portion is arranged in completely encircling manner around the media throughflow opening.

24. The heat shield according to claim 18, wherein the sealing element consists of a metal sheet with a tensile strength of at least 1000 N/mm².

25. The heat shield according to claim 18, wherein at least one of the at least one shielding layer(s), including all of the at least one shielding layer(s), comprises a metal sheet with a tensile strength of less than 800 N/mm².

26. The heat shield according to claim 18, wherein the media throughflow openings of the sealing element and of the at least one shielding layer are arranged coaxially or with centre lines running parallel to each other.

27. The heat shield according to claim 18, wherein the shielding layer has at least one fastening region for screw holes for fastening the heat shield to a component.

28. The heat shield according to claim 18, wherein the total of the thicknesses of the at least one shielding layer D_{A} relative to the thickness of the sealing element D_{D} is formed in such a way that 10≥D_{A}/D_{D}≥≥1.5, including 8≥D_{A}/D_{D}≥1.8, including 6≥D_{A}/D_{D}≥2.

29. The heat shield according to claim 18, wherein the at least one shielding layer and the sealing element in each case have a plurality of media throughflow openings, with in each case one media throughflow opening of the at least one shielding layer and one media throughflow opening of the sealing element being arranged adjacent to each other in the direction of throughflow.

30. The heat shield according to claim 18, wherein at least for some of the media throughflow openings the axes through the media throughflow openings intersect a line which runs perpendicularly to the axes.

31. The heat shield according to claim 18, wherein the at least one shielding layer is undivided in its surface plane and the sealing element consists of a single element.

32. The heat shield according to claim 18, wherein the at least one shielding layer is undivided in its surface plane and the sealing element consists of a plurality of elements arranged next to one another in the face of the sealing element, each element having at least one media throughflow opening.
